(19) United States
(12) Patent Application Publication
(10) Pub. No.: US 2025/0104912 A1
(43) Pub. Date: Mar. 27, 2025

(54) CAPACITOR, CAPACITOR BANK, AND OUTER CASE FOR CAPACITOR

(71) Applicant: Murata Manufacturing Co., Ltd., Nagaokakyo-shi (JP)

(72) Inventor: Shoji OKA, Nagaokakyo-shi (JP)

(21) Appl. No.: 18/976,695

(22) Filed: Dec. 11, 2024

Related U.S. Application Data
(63) Continuation of application No. PCT/JP2023/016312, filed on Apr. 25, 2023.

(30) Foreign Application Priority Data
Jun. 17, 2022 (JP) 2022-098188

(51) Int. Cl. H01G 2/02; H01G 4/224; H01G 4/236; H01G 4/38

(52) U.S. Cl. CPC H01G 2/02; H01G 4/224; H01G 4/236; H01G 4/38

(57) ABSTRACT

A capacitor including: a capacitor element including a body and an external electrode on an end surface of the body; a lead-out terminal electrically connected to the external electrode; an outer case housing the capacitor element such that the lead-out terminal protrudes outward therefrom, wherein an outer surface of the outer case includes a mounting surface that faces a mounting object in a first direction when the lead-out terminal is welded to the mounting object; a filling resin filling the outer case such that the capacitor element is embedded in the filling resin; and a mounting foot on the outer surface of the outer case for welding the outer case to the mounting object at the mounting surface, the mounting foot being electrically isolated from the lead-out terminal and including a metal material of a same type as that of the lead-out terminal.

### CROSS REFERENCE TO RELATED APPLICATIONS

The present application is a continuation of International application No. PCT/JP2023/016312, filed Apr. 25, 2023, which claims priority to Japanese Patent Application No. 2022-098188, filed Jun. 17, 2022, the entire contents of each of which are incorporated herein by reference.

### TECHNICAL FIELD

The present disclosure relates to a capacitor, a capacitor bank, and a capacitor outer case.

### BACKGROUND ART

Patent Literature 1 discloses a case-molded capacitor, wherein a plurality of elements each having two electrodes, one at one end surface and the other one at the other end surface, are arranged in parallel and connected to bus bars each including a terminal for external connection at one end, and a case in which these elements are housed is molded with resin, excluding at least the terminals of the bus bars. The case-molded capacitor includes a mounting foot for mounting the case on an object on which the case is to be mounted which is located at an opening end of the case, without overlapping any element in the top view.

Patent Literature 2 discloses a chip-type multi-electronic component, wherein storage holes that contain a plurality of electronic parts are formed in a package of heat-resistant insulating resin whose bottom surface acts as a mounting surface, and a lead wire of the electronic component is led out of an opening part communicating with a storage hole, and further the lead wire is bent along an engaging wall part provided to the package and a tip thereof acts as a terminal part, thereby constituting a chip-type multi-electronic component. In the chip-type multi-electronic component, the terminal is bent so as to be flush with the bottom surface of the package, and further a dummy terminal is formed integrally on the bottom surface of the package.

Patent Literature 1: JP 2009-252935 A

Patent Literature 2: JP 2000-306770 A

### SUMMARY OF THE DISCLOSURE

In recent years, efforts to save energy have been made in various industries from the perspective of environmental protection. For example, in the automobile industry, energy-saving technologies have been increasingly developed, as seen in electrically-powered vehicles such as electric vehicles, hybrid vehicles, and fuel cell vehicles.

Against this background, electrical and electronic components for use in in-vehicle applications such as power converters for electric vehicles are required to be not only energy efficient but also highly resistant to vibration and shock, because these components are used in in-vehicle applications. Thus, electrical and electronic components for use in in-vehicle applications need to be firmly fixed to mounting objects. For example, smoothing capacitors for use in DC-links of electric systems are relatively large and heavy, and thus particularly need to be firmly fixed to mounting objects.

In the case-molded capacitor disclosed in Patent Literature 1, as shown in FIG. 1 and the like of Patent Literature 1, the case in which the capacitor elements are housed includes a mounting foot for mounting the case on an object on which the case is to be mounted. Patent Literature 1 is silent about any specific method for mounting the case on the object, but it is presumed based on the shape of the mounting foot shown in FIG. 1 and the like of Patent Literature 1 that the technique assumes application of screwing. However, in the case-molded capacitor disclosed in Patent Literature 1, when the case is screwed into the object, screws may come off due to vibration, shock, or the like. Thus, there is a room for improvement of vibration and shock resistance.

In the chip-type multi-electronic component disclosed in Patent Literature 2, as shown in FIG. 1 and the like of Patent Literature 2, multiple electrolytic capacitors as electronic parts are housed in the outer case, and a dummy terminal at the bottom of the outer case is fixed to a printed circuit board by soldering. However, H in the chip-type multi-electronic component disclosed in Patent Literature 2, the solder may break due to vibration, shock, or the like. Thus, there is a room for improvement of vibration and shock resistance.

The present disclosure was made to solve the above issues and aims to provide a capacitor capable of improving vibration and shock resistance while it is mounted on a mounting object. The present disclosure also aims to provide a capacitor bank including the capacitor. Further, the present disclosure aims to provide a capacitor outer case for use in the capacitor.

A capacitor of the present disclosure includes: a capacitor element including a body and an external electrode on an end surface of the body; a lead-out terminal electrically connected to the external electrode; an outer case housing the capacitor element such that the lead-out terminal protrudes outward therefrom, wherein an outer surface of the outer case includes a mounting surface that faces a mounting object in a first direction when the lead-out terminal is welded to the mounting object; a filling resin filling the outer case such that the capacitor element is embedded in the filling resin; and a mounting foot on the outer surface of the outer case for welding the outer case to the mounting object at the mounting surface, the mounting foot being electrically isolated from the lead-out terminal and including a metal material of a same type as that of the lead-out terminal.

The capacitor bank of the present disclosure includes the capacitor of the present disclosure, and the mounting object to which the lead-out terminal and the mounting foot of the capacitor are welded.

A capacitor outer case of the present disclosure includes: a housing body configured to house a capacitor element such that a lead-out terminal of the capacitor element protrudes outward therefrom, wherein an outer surface of the housing body includes a mounting surface; and a mounting foot on the outer surface of the housing body for welding the housing body to a mounting object at a mounting surface.

The present disclosure can provide a capacitor capable of improving the vibration and shock resistance while it is mounted on a mounting object. The present disclosure can also provide a capacitor bank including the capacitor. Further, the present disclosure can provide a capacitor outer case for use in the capacitor.

### BRIEF DESCRIPTION OF THE DRAWINGS

FIG. 1 is a schematic perspective view of an example of a capacitor of the present disclosure.

FIG. 2 is a schematic perspective view of the capacitor shown in FIG. 1 as viewed in a direction different from that in FIG. 1.

FIG. 3 is a schematic perspective view of the capacitor shown in FIG. 1 and FIG. 2 as viewed in a direction different from those in FIG. 1 and FIG. 2.

FIG. 4 is a schematic view of the capacitor shown in FIG. 1, FIG. 2, and FIG. 3 as viewed from a second surface side of an outer case.

FIG. 5 is a schematic perspective view of an example of the capacitor element shown in FIG. 1, FIG. 2, FIG. 3, and FIG. 4.

FIG. 6 is a schematic view of an example of a cross section taken along line a1-a2 of the capacitor element shown in FIG. 5.

FIG. 7 is a schematic perspective view of another example of the capacitor of the present disclosure.

FIG. 8 is a schematic view of the capacitor shown in FIG. 7 as viewed from a first surface side of an outer case.

FIG. 9 is a schematic perspective view of an example of the capacitor bank of the present disclosure.

FIG. 10 is a schematic perspective view of the capacitor bank shown in FIG. 9 as viewed in a direction different from that in FIG. 9.

FIG. 11 is a schematic view of the capacitor bank shown in FIG. 9 and FIG. 10 as viewed from a second surface side of an outer case.

FIG. 12 is an enlarged schematic view of a portion of the capacitor bank shown in FIG. 10.

FIG. 13 is a schematic view of a portion of the capacitor bank shown in FIG. 12 as viewed from a first surface side of the outer case.

### DESCRIPTION OF THE PREFERRED EMBODIMENTS

Hereinafter, the capacitor of the present disclosure, the capacitor bank of the present disclosure, and the capacitor outer case of the present disclosure are described. The present disclosure is not limited to the following preferred embodiments, and may be suitably modified without departing from the gist of the present disclosure. Combinations of two or more preferred features described in the following preferred embodiments are also within the scope of the present disclosure.

Hereinafter, a film capacitor is described as an example of the capacitor of the present disclosure. The capacitor of the present disclosure is also applicable to a capacitor different from the film capacitor.

The drawings shown below are schematic, and factors such as dimensions and aspect ratio scales may be different from those of actual products.

The capacitor of the present disclosure includes: a capacitor element including a body and an external electrode on an end surface of the body; a lead-out terminal electrically connected to the external electrode; an outer case housing the capacitor element such that the lead-out terminal protrudes outward therefrom, wherein an outer surface of the outer case includes a mounting surface that faces a mounting object in a first direction when the lead-out terminal is welded to the mounting object; a filling resin filling the outer case such that the capacitor element is embedded in the filling resin; and a mounting foot on the outer surface of the outer case for welding the outer case to the mounting object at the mounting surface, the mounting foot being electrically isolated from the lead-out terminal and including a metal material of a same type as that of the lead-out terminal.

A capacitor outer case for use in the capacitor of the present disclosure described hereinafter is also encompassed by the present disclosure. Specifically, the capacitor outer case of the present disclosure includes: a housing body configured to house a capacitor element such that a lead-out terminal of the capacitor element protrudes outward therefrom, wherein an outer surface of the housing body includes a mounting surface; and a mounting foot on the outer surface of the housing body for welding the housing body to a mounting object at a mounting surface, the mounting surface being configured to face the mounting object in a first direction.

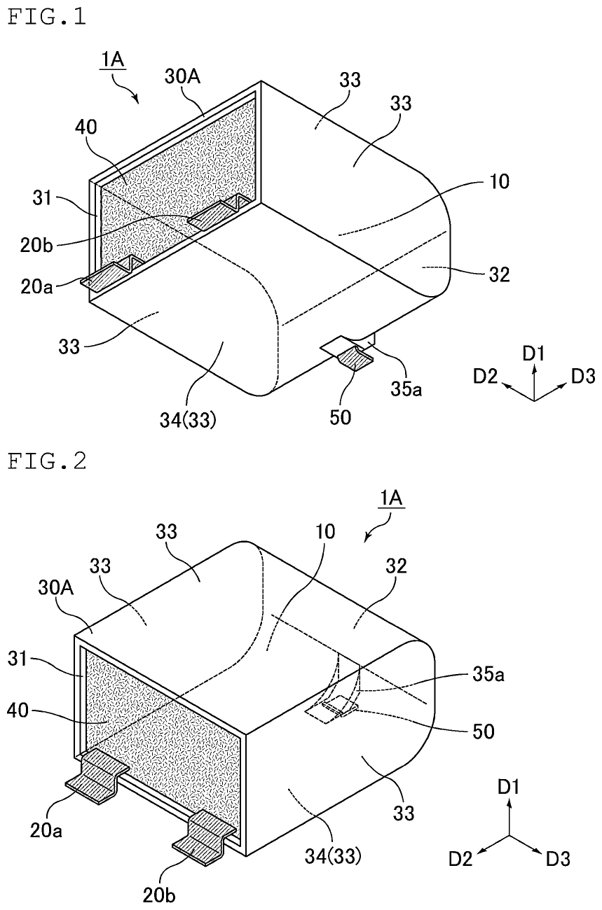

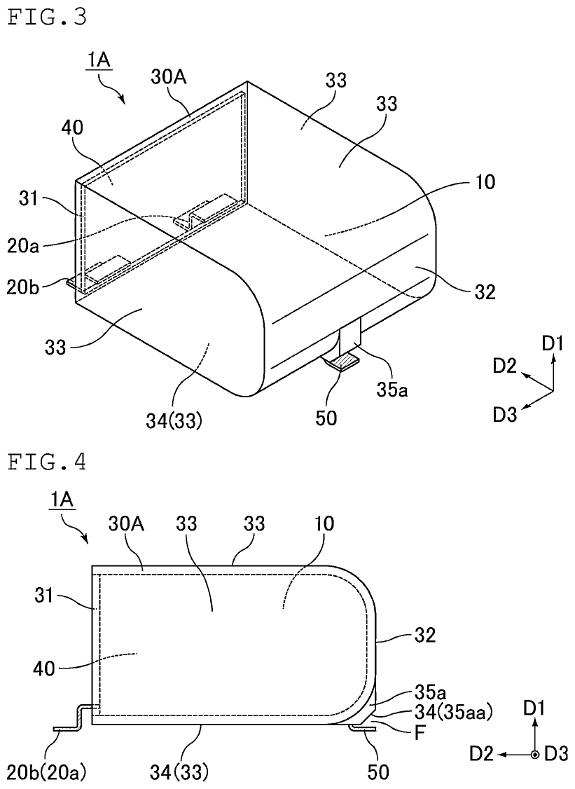

FIG. 1 is a schematic perspective view of an example of a capacitor of the present disclosure. FIG. 2 is a schematic perspective view of the capacitor shown in FIG. 1 as viewed in a direction different from that in FIG. 1. FIG. 3 is a schematic perspective view of the capacitor shown in FIG. 1 and FIG. 2 as viewed in a direction different from those in FIG. 1 and FIG. 2. FIG. 4 is a schematic view of the capacitor shown in FIG. 1, FIG. 2, and FIG. 3 as viewed from a second surface side of the outer case.

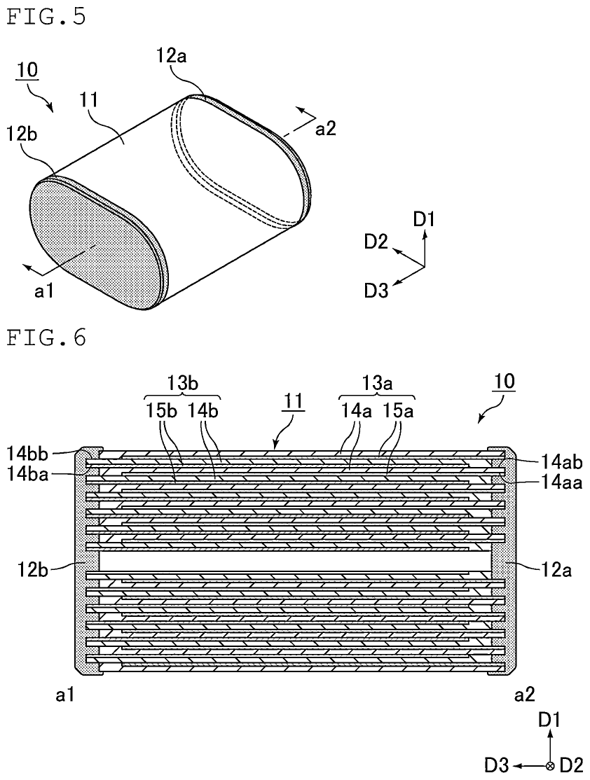

A capacitor 1A shown in FIG. 1, FIG. 2, FIG. 3, and FIG. 4 includes a capacitor element 10 (see FIG. 5 described later), a first lead-out terminal 20a, a second lead-out terminal 20b, an outer case 30A, and a filling resin 40.

In FIG. 1 and the like, a first direction D1, a second direction D2, and a third direction D3 are mutually perpendicular.

FIG. 5 is a schematic perspective view of an example of the capacitor element shown in FIG. 1, FIG. 2, FIG. 3, and FIG. 4. FIG. 6 is a schematic view of an example of a cross section taken along line a1-a2 of the capacitor element shown in FIG. 5.

The capacitor element 10 shown in FIG. 5 and FIG. 6 includes a body 11, a first external electrode 12a, and a second external electrode 12b.

The body 11 is a wound body in which a first metallized film 13a and a second metallized film 13b are wound in a laminated state in the first direction D1. In other words, the capacitor 1A, specifically, the capacitor element 10, is a wound film capacitor in which metallized films are wound in a laminated state.

The capacitor 1A, specifically, the capacitor element 10, may be a multilayer film capacitor in which metallized films are laminated.

To reduce the height of the capacitor element 10, preferably, the body 11 has a flat cross-sectional shape as viewed in a cross section perpendicular to a spool direction (third direction D3 in FIG. 5) of the body 11. Specifically, the body 11 is preferably pressed into a flat shape having an oval or oblong cross section so that the shape is thinner than the shape of the body 11 having a perfectly circular cross section.

Whether the body is pressed to have a flat cross section can be determined by, for example, checking whether a press mark is present on the body.

The capacitor element 10 may include a cylindrical winding shaft. The winding shaft is disposed along the central axis of the first metallized film 13a and the second metallized film 13b in a wound state and serves as a spool in winding the first metallized film 13a and the second metallized film 13b.

The first metallized film 13a includes a first dielectric film 14a and a first metal layer 15a.

The first dielectric film 14a includes a first main surface 14aa and a second main surface 14ab facing each other in the first direction D1.

The first metal layer 15a is on the first main surface 14aa of the first dielectric film 14a. Specifically, the first metal layer 15a is on the first main surface 14aa of the first dielectric film 14a such that it extends to one side edge of the first dielectric film 14a but not to the other side edge of the first dielectric film 14a in the third direction D3.

The second metallized film 13b includes a second dielectric film 14b and a second metal layer 15b.

The second dielectric film 14b includes a first main surface 14ba and a second main surface 14bb facing each other in the first direction D1.

The second metal layer 15b is on the first main surface 14ba of the second dielectric film 14b. Specifically, the second metal layer 15b is on the first main surface 14ba of the second dielectric film 14b such that it extends to one side edge of the second dielectric film 14b but not to the other side edge of the second dielectric film 14b in the third direction D3.

In the body 11, the first metallized film 13a and the second metallized film 13b adjacent to each other are shifted from each other in the third direction D3 such that the end of the first metal layer 15a which extends to the side edge of the first dielectric film 14a is exposed on one end surface of the body 11 and that the end of the second metal layer 15b which extends to the side edge of the second dielectric film 14b is exposed on the other end surface of the body 11. In other words, the first metallized film 13a and the second metallized film 13b adjacent to each other are arranged such that the first metallized film 13a protrudes toward the first external electrode 12a with respect to the second metallized film 13b. The first metallized film 13a and the second metallized film 13b adjacent to each other are also arranged such that the second metallized film 13b protrudes toward the second external electrode 12b with respect to the first metallized film 13a. In this state, the first metal layer 15a is connected to the first external electrode 12a and is not connected to the second external electrode 12b. The second metal layer 15b is connected to the second external electrode 12b and is not connected to the first external electrode 12a.

In the body 11, the first metallized film 13a and the second metallized film 13b adjacent to each other are shifted from each other in the third direction D3 as described above. Thus, the first dielectric film 14a and the second dielectric film 14b adjacent to each other are arranged such that the first dielectric film 14a provided with the first metal layer 15a on the first main surface 14aa protrudes toward the first external electrode 12a with respect to the second dielectric film 14b not provided with the first metal layer 15a on the main surfaces. The first dielectric film 14a and the second dielectric film 14b adjacent to each other are also arranged such that the second dielectric film 14b provided with the second metal layer 15b on the first main surface 14ba protrudes toward the second external electrode 12b with respect to the first dielectric film 14a not provided with the second metal layer 15b on the main surfaces.

The body 11, in which the first metallized film 13a and the second metallized film 13b are wound while being laminated in the first direction D1, can be regarded as including the first dielectric film 14a, the first metal layer 15a, the second dielectric film 14b, and the second metal layer 15b sequentially in the first direction D1. The body 11 can also be regarded as a wound body in which the first dielectric film 14a, the first metal layer 15a, the second dielectric film 14b, and the second metal layer 15b are wound while being sequentially laminated in the first direction D1.

In the body 11, the first main surface 14aa of the first dielectric film 14a and the second main surface 14bb of the second dielectric film 14b face each other in the first direction D1, and the second main surface 14ab of the first dielectric film 14a and the first main surface 14ba of the second dielectric film 14b face each other in the first direction D1. In this way, in the body 11, the first metallized film 13a and the second metallized film 13b are wound while being laminated in the first direction D1. In other words, in the body 11, the second metallized film 13b comes inside the first metallized film 13a. Specifically, the first metallized film 13a and the second metallized film 13b are wound while being laminated in the first direction D1 such that the first metal layer 15a comes inside the first dielectric film 14a and that the second metal layer 15b comes insides the second dielectric film 14b. In other words, in the body 11, the first metal layer 15a and the second metal layer 15b face each other across the first dielectric film 14a or the second dielectric film 14b.

The first metal layer 15a may include fuse portions. For example, the fuse portions of the first metal layer 15a connect divided electrode portions, which are obtained by dividing a portion of the first metal layer 15a facing the second metal layer 15b into multiple portions, to an electrode portion not facing the second metal layer 15b. Examples of electrode patterns for the first metal layer 15a provided with fuse portions include those disclosed in JP 2004-363431 A and JP H5-251266 A.

As with the first metal layer 15a, the second metal layer 15b may include fuse portions.

The first dielectric film 14a may contain a curable resin as a main component.

The term “main component” as used herein refers to a component with the highest weight percentage, and preferably refers to a component whose weight percentage is more than 50 wt %.

The curable resin may be a thermosetting resin or a photocurable resin.

The term “thermosetting resin” as used herein refers to a heat-curable resin, and the curing method is not limited. Thus, the thermosetting resin encompasses a resin curable by a method other than heat (e.g., light or electron beam) as long as the resin is heat-curable. Some materials may start a reaction due to their own reactivity. The thermosetting resin also encompasses such materials that do not necessarily require external heat or the like to start curing. The same applies to the photocurable resin. The photocurable resin encompasses a resin curable by a method other than light (e.g., heat) as long as the resin is photocurable.

The curable resin preferably includes a cured product of a first organic material containing hydroxy groups (OH groups) and a second organic material containing isocyanate groups (NCO groups). In this case, the curable resin includes a cured product having urethane bonds resulting from reaction between the hydroxy groups of the first organic material and the isocyanate groups of the second organic material.

The presence of urethane bonds in the dielectric films can be determined by analysis using a Fourier transform infrared spectrophotometer (FT-IR).

When the curable resin is obtained by the above reaction, the first dielectric film 14a may contain uncured residues of the starting materials. For example, the first dielectric film 14a may contain at least one of a hydroxy group or an isocyanate group. In this case, the first dielectric film 14a may contain either one or both of a hydroxy group and an isocyanate group.

The presence of a hydroxy group and/or an isocyanate group in the dielectric films can be determined by analysis using a FT-IR.

Examples of the first organic material include phenoxy resins, polyvinyl acetoacetal resins, and polyvinyl butyral resins.

The first organic material may be any combination of two or more organic materials.

Examples of the second organic material include aromatic polyisocyanates such as diphenylmethane diisocyanate (MDI) and tolylene diisocyanate (TDI) and aliphatic polyisocyanates such as hexamethylene diisocyanate (HDI). The second organic material may be a modified product of at least one of these polyisocyanates, or a mixture of at least one of these polyisocyanates and a modified product thereof.

The second organic material may be any combination of two or more organic materials.

The first dielectric film 14a may contain a thermoplastic resin as a main component.

Examples of the thermoplastic resin include polypropylene, polyethersulfone, polyetherimide, and polyarylate.

The first dielectric film 14a may contain additives that provide various functions.

Examples of additives include leveling agents for providing smoothness.

A preferred additive is one having a functional group that reacts with a hydroxy group and/or an isocyanate group and forming a part of the crosslinked structure of the cured product. Examples of such an additive include a resin having at least one functional group selected from the group consisting of a hydroxy group, an epoxy group, a silanol group, and a carboxy group.

As with the first dielectric film 14a, the second dielectric film 14b may also contain a curable resin as a main component or a thermoplastic resin as a main component. As with the first dielectric film 14a, the second dielectric film 14b may also contain additives.

The first dielectric film 14a and the second dielectric film 14b may have different compositions, but preferably have the same composition.

The thickness of each of the first dielectric film 14a and the second dielectric film 14b is preferably 1 μm to 10 μm, more preferably 3 μm to 5 μm.

The first dielectric film 14a and the second dielectric film 14b may have different thicknesses, but preferably have the same thickness.

The thickness of each dielectric film is measured with an optical film thickness gauge.

Preferably, the first dielectric film 14a and the second dielectric film 14b are each produced by forming a resin solution containing a resin material such as one described above into a film shape and curing the film by heat treatment.

Examples of constituents of the first metal layer 15a and the second metal layer 15b include metals such as aluminum, zinc, titanium, magnesium, tin, and nickel.

The first metal layer 15a and the second metal layer 15b may have different compositions, but preferably have the same composition.

Preferably, the first metal layer 15a and the second metal layer 15b each have a thickness of 5 nm to 40 nm.

The first metal layer 15a and the second metal layer 15b may have different thicknesses, but preferably have the same thickness.

The thickness of each metal layer can be determined by observing a cross section of the metallized films in the first direction using a transmission electron microscope (TEM).

Preferably, the first metal layer 15a and the second metal layer 15b are formed by vapor deposition of a metal such as one described above onto main surfaces of the first dielectric film 14a and the second dielectric film 14b, respectively.

The first external electrode 12a is on one end surface of the body 11. Specifically, the first external electrode 12a is connected to the first metal layer 15a by contacting an end of the first metal layer 15a which is exposed on one end surface of the body 11. The first external electrode 12a is not connected to the second metal layer 15b.

The second external electrode 12b is on the other end surface of the body 11. Specifically, the second external electrode 12b is connected to the second metal layer 15b by contacting an end of the second metal layer 15b which is exposed on the other end surface of the body 11. The second external electrode 12b is not connected to the first metal layer 15a.

Examples of constituents of the first external electrode 12a and the second external electrode 12b include metals such as zinc, aluminum, tin, and zinc-aluminum alloys.

The first external electrode 12a and the second external electrode 12b may have different compositions, but preferably have the same composition.

Preferably, the first external electrode 12a and the second external electrode 12b are formed by thermally spraying a metal such as the one mentioned above on the end surface and the other end surface of the body 11, respectively.

The first lead-out terminal 20a is electrically connected to the first external electrode 12a (see FIG. 5 and FIG. 6). For example, the first lead-out terminal 20a is electrically connected to the first external electrode 12a via a bonding member such as solder.

The second lead-out terminal 20b is electrically connected to the second external electrode 12b (see FIG. 5 and FIG. 6). For example, the second lead-out terminal 20b is electrically connected to the second external electrode 12b via a bonding member such as solder.

The first lead-out terminal 20a and the second lead-out terminal 20b are each a lead-out terminal for welding the capacitor element 10 to a mounting object.

When mounting the capacitor 1A is on a mounting object, the first lead-out terminal 20a and the second lead-out terminal 20b are welded to the mounting object. Thus, the capacitor 1A, specifically the capacitor element 10, can be firmly fixed to the mounting object, compared to when the first lead-out terminal 20a and the second lead-out terminal 20b are fixed to the mounting object by screwing, soldering, or the like. This can improve the vibration and shock resistance while the capacitor 1A is mounted on the mounting object.

Further, when mounting the capacitor 1A is on a mounting object, the first lead-out terminal 20a and the second lead-out terminal 20b are welded to the mounting object. Thus, the connection resistance between the first lead-out terminal 20a and the mounting object and the connection resistance between the second lead-out terminal 20b and the mounting object can be reduced. This can improve the conductivity between the capacitor 1A and the mounting object.

The first lead-out terminal 20a and the second lead-out terminal 20b each may have a plate shape or a linear shape (rod shape), for example. In this case, the first lead-out terminal 20a and the second lead-out terminal 20b each may have a partially bent shape.

Inside the outer case 30A, the capacitor element 10 (see FIG. 5 and FIG. 6) is housed such that the first lead-out terminal 20a and the second lead-out terminal 20b protrude outward. Although not shown in FIG. 1 and the like, preferably, the capacitor element 10 is housed at the center in the outer case 30A, with a distance from inner surfaces of the outer case 30A.

The outer case 30A has a bottomed cylindrical shape with an opening 31 at one end in the second direction D2, as shown in FIG. 1 and the like, for example.

In the examples shown in FIG. 1 and the like, outer surfaces of the outer case 30A include a first surface 32 facing the opening 31 in the second direction D2 and second surfaces 33 extending from the first surface 32 to the opening 31 in the second direction D2 (there are four second surfaces 33 in the examples shown in FIG. 1 and the like).

The outer case 30A may be a resin case, a metal case, or the like, for example.

When the outer case 30A is a resin case, the resin case may include a resin such as a liquid crystal polymer (LCP), polyphenylene sulfide, polybutylene terephthalate, or the like. In particular, the resin case preferably includes a liquid crystal polymer.

The liquid crystal polymer in the resin case may be a liquid crystal polymer containing p-hydroxybenzoic acid and a 6-hydroxy-2-naphthoic acid group in the skeleton. Another liquid crystal polymer that can be used other than p-hydroxybenzoic acid and 6-hydroxy-2-naphthoic acid group is one obtained by polycondensation of various components such as phenol, phthalic acid, and ethylene terephthalate. Liquid crystal polymers can be classified into type I, type II, and type III according to a classification method. Yet, the materials of the liquid crystal polymers are the same as those of the liquid crystal polymers formed from the above-described components.

Preferably, the resin case further includes an inorganic filler, in addition to the liquid crystal polymer.

The inorganic filler to be included in the resin case may be a material having higher strength than the liquid crystal polymer. The inorganic filler is preferably a material having a higher melting point than the liquid crystal polymer, more preferably a material having a melting point of 680° C. or higher.

The inorganic filler may be in any form. For example, a filler having a shape with a longitudinal direction, such as a fibrous shape or a plate shape, may be mentioned. The inorganic filler having such a shape may include a combination of multiple types of inorganic fillers. Preferably, the resin case includes at least one of a fibrous inorganic material or a plate-shaped inorganic material as the inorganic filler.

Herein, that “the filler is fibrous” refers to a state in which the relationship between the longitudinal dimension and the cross-sectional diameter in a cross section perpendicular to the longitudinal direction of the filler satisfies the following: longitudinal dimension/cross-sectional diameter ≥5 (i.e., the aspect ratio is 5:1 or greater). Here, the cross-sectional diameter is the longest distance between two points on an outer periphery of the cross section. When the cross-sectional diameter varies in the longitudinal direction, a portion with the largest cross-sectional diameter is used for measurement.

Herein, that “the filler is plate-shaped” refers to a state in which the relationship between the cross-sectional diameter of a surface having the largest projected area and the maximum height in a direction perpendicular to the cross section of the filler satisfies the following: cross-sectional diameter/the maximum height ≥3.

Preferably, on each of the second surfaces 33 of the outer case 30A, the inorganic filler includes at least a portion oriented from the first surface 32 toward the opening 31 and at least a portion oriented from one second surface 33 toward its adjacent second surface 33, and the inorganic filler is dispersed in the outer case 30A.

Preferably, the inorganic filler size is 5 μm or more in diameter and 50 μm or more in length.

Preferably, the inorganic filler is dispersed throughout the outer case 30A, without being aggregated.

Examples of the inorganic filler include inorganic materials such as fibrous glass filler, plate-shaped talc, and plate-shaped mica. In particular, the inorganic filler preferably includes fibrous glass filler as a main component.

Also in the case where the resin case includes another resin (e.g., polyphenylene sulfide) instead of the liquid crystal polymer, preferably, the resin case further includes an inorganic filler such as the one mentioned above.

The resin case can be produced by a method such as injection molding.

When the outer case 30A is a metal case, examples of the metal of the metal case include elemental metals such as aluminum, magnesium, iron, stainless steel, and copper, and alloys containing at least one of these elemental metals. In particular, the metal case preferably includes aluminum or an aluminum alloy.

The metal case is produced by, for example, a method such as impact molding.

In the examples shown in FIG. 1 and the like, one capacitor element 10 is housed in one outer case 30A, but multiple capacitor elements 10 may be housed in one outer case 30A.

The filling resin 40 fills the outer case 30A such that the capacitor element 10 is embedded in the filling resin 40. The capacitor element 10 is held in the outer case 30A as the outer case 30A is filled with the filling resin 40 as described above.

When the capacitor element 10 is housed in the outer case 30A with a distance from the inner surfaces of the outer case 30A, the filling resin 40 fills the space between the capacitor element 10 and the outer case 30A, specifically, the space between the outer surfaces of the capacitor element 10 and the inner surfaces of the outer case 30A. Further, inside the outer case 30A, the filling resin 40 also fills an area extending from the opening 31 of the outer case 30A to the capacitor element 10, in addition to the space between the capacitor element 10 and the outer case 30A.

Preferably, a low moisture-permeable resin is selected as the filling resin 40 in order to prevent moisture from entering the capacitor element 10. Examples include epoxy, silicone, and urethane resins. A curing agent for epoxy resins may be an amine curing agent or an imidazole curing agent.

Any of the resins described above may be used alone as the filling resin 40, or a reinforcing agent may be added to the resin to improve the strength. The reinforcing agent may be silica, alumina, or the like.

Preferably, the thickness of the filling resin 40 at the opening 31 of the outer case 30A is large in order to prevent moisture from entering the capacitor element 10. Preferably, the thickness of the filling resin 40 at the opening 31 of the outer case 30A is sufficiently large within the range that allows for volume (physical size) of the entire capacitor 1A. Specifically, the thickness is preferably 2 mm or more, more preferably 4 mm or more. In particular, preferably, the thickness of the filling resin 40 relative to the capacitor element 10 is larger at the opening 31 than at the first surface 32 of the outer case 30A by arranging the capacitor element 10 at a position closer to the first surface 32 than to the opening 31 of the outer case 30A inside the outer case 30A.

For example, the thickness of the filling resin 40 is measured with a soft X-ray apparatus when the filling resin 40 is in a non-destructive state, and is measured with a measuring device such as a caliper when the filling resin 40 is in a destructive state.

Regarding the relationship between the height of the outer case 30A and the height of the filling resin 40 in the second direction D2, the filling resin 40 may fill to a position inside the outer case 30A or substantially to the level of the opening 31 or may slightly overflow due to surface tension, while the thickness of the filling resin 40 at the opening 31 of the outer case 30A is made as large as possible.

The outer surfaces of the outer case 30A include a mounting surface 34 that faces a mounting object in the first direction D1 when the first lead-out terminal 20a and the second lead-out terminal 20b are welded to the mounting object. In the examples shown in FIG. 1 and the like, the outer surfaces of the outer case 30A include the mounting surface 34 as a part of the second surfaces 33.

The outer surface of the outer case 30A is provided with a mounting foot 50.

In the examples shown in FIG. 1 and the like, the mounting foot 50 is attached to a first rib 35a on the outer surface, here, the mounting surface 34 (the second surface 33), of the outer case 30A. As described above, in the examples shown in FIG. 1 and the like, the mounting surface 34 of the outer case 30A is provided with the mounting foot 50.

The mounting foot 50 is attached to the first rib 35a by a method such as insert molding.

The first rib 35a may have any shape.

None of the outer surfaces of the outer case 30A may be provided with the first rib 35a. In other words, the mounting foot 50 may be at a portion other than the first rib 35a of the outer case 30A.

The mounting foot 50 is a mounting foot for welding the outer case 30A to a mounting object at the mounting surface 34.

When mounting the capacitor 1A is on a mounting object, the mounting foot 50 is welded to the mounting object. Thus, the capacitor 1A, specifically the outer case 30A, can be firmly fixed to the mounting object, compared to when the mounting foot 50 is fixed to a mounting object by screwing, soldering, or the like. This can improve the vibration and shock resistance while the capacitor 1A is mounted on the mounting object.

Further, when mounting the capacitor 1A is on a mounting object, the mounting foot 50 can be welded to the mounting object by the same step as that for welding the first lead-out terminal 20a and the second lead-out terminal 20b to a mounting object. Thus, when mounting the capacitor 1A is on a mounting object, a conventional fixing step such as fixing a capacitor to a mounting object by screwing or the like is unnecessary, which can thus reduce the time, cost, and the like required for fixing the capacitor to the mounting object.

In the capacitor 1A, the mounting foot 50 is electrically isolated from the first lead-out terminal 20a and the second lead-out terminal 20b. In other words, in the capacitor 1A, the mounting foot 50 is electrically isolated from the capacitor element 10 to which the first lead-out terminal 20a and the second lead-out terminal 20b are electrically connected.

The mounting foot 50 includes a metal material of the same type as that of the first lead-out terminal 20a and the second lead-out terminal 20b. Thus, when mounting the capacitor 1A is on a mounting object, the mounting foot 50 can be welded to the mounting object by the same welding method as that for the first lead-out terminal 20a and the second lead-out terminal 20b.

Herein, that “the multiple members include a metal material of the same type” means that a basic component of the metal material includes a metal element of the same type between each member. The basic component of the metal material may include only one metal element or multiple metal elements. When the basic component of the metal material includes multiple metal elements, for example, in comparison between two members, when the basic component of the metal material of one member includes metal elements E1 and E2, and the basic component of the metal material of the other member includes metal elements E1 and E2, these members are regarded as including the same types of metal materials. The same applies when comparing three or more members. The amount of the basic component in the metal material may be the same among multiple members, may be different between each member, or may be different in one or some members. When the basic component of the metal material includes multiple metal elements, the weight ratio of the multiple metal elements in the basic component may be the same among multiple members, may be different between each member, or may be different in one or some members. The metal material may also contain 1 wt % or less additive component, in addition to the basic component. The metal element type of the additive component of the metal material may be the same among multiple members, may be different between each member, or may be different in one or some members. The additive component of the metal material may include only one metal element or multiple metal elements. The amount of the additive component in the metal material may be the same among multiple members, may be different between each member, or may be different in one or some members. When the additive component of the metal material includes multiple metal elements, the weight ratio of the multiple metal elements in the additive component may be the same among multiple members, may be different between each member, or may be different in one or some members. The metal material may not contain any additive component. Among multiple members, the metal materials of all the members may contain an additive component, the metal materials of one or some members may contain an additive component, or the metal materials of all the members may not contain an additive component.

Examples of the metal material of the first lead-out terminal 20a, the second lead-out terminal 20b, and the mounting foot 50 include copper, oxygen-free copper, aluminum, and alloys containing at least one of these elemental metals. In particular, the metal material of the first lead-out terminal 20a, the second lead-out terminal 20b, and the mounting foot 50 is preferably copper or oxygen-free copper. When the metal material of the first lead-out terminal 20a, the second lead-out terminal 20b, and the mounting foot 50 is a copper-based material, for example, oxygen-free copper (copper: 99.96 wt % or more), tough pitch copper (copper: 99.90 wt % or more), phosphorus deoxidized copper (copper: 99.90 wt % or more, phosphorus: 0.015 wt % or more, 0.040 wt % or less), or the like can be used.

The first lead-out terminal 20a, the second lead-out terminal 20b, and the mounting foot 50 are welded to a mounting object by a welding method such as laser welding or resistance welding. In particular, laser welding is advantageous in that welding distortion can be reduced because laser welding enables rapid welding by localized heating, compared to other welding methods.

As shown in FIG. 1 and the like, preferably, the mounting foot 50 protrudes outward relative to the mounting surface 34 of the outer case 30A in the first direction D1. In this case, while the capacitor 1A is mounted on a mounting object, a gap can be provided between the mounting surface 34 of the outer case 30A and the mounting object. Further, while the capacitor 1A is mounted on the mounting object, the gap between the mounting surface 34 of the outer case 30A and the mounting object can be used as a place where a connecting member such as a heat dissipation paste or an underfill adhesive (e.g., an adhesive containing an epoxy resin) is disposed. For example, with a heat dissipation paste between the mounting surface 34 of the outer case 30A and a mounting object, the heat dissipation performance of the capacitor 1A is easily adjusted to a desired level. With an underfill adhesive between the mounting surface 34 of the outer case 30A and a mounting object, the capacitor 1A, specifically the outer case 30A, can be sufficiently firmly fixed to the mounting object.

From a similar perspective, as shown in FIG. 1 and the like, preferably, the first lead-out terminal 20a and the second lead-out terminal 20b each protrude outward relative to the mounting surface 34 of the outer case 30A in the first direction D1.

The distance between the mounting surface 34 of the outer case 30A and a mounting object, with the capacitor 1A mounted on the mounting object, can be adjusted by shapes of the first lead-out terminal 20a, the second lead-out terminal 20b, and the mounting foot 50.

As shown in FIG. 4, preferably, a space F is provided between the mounting surface 34 and the mounting foot 50 of the outer case 30A. In the example shown in FIG. 4, the space F is provided between a first surface 35aa of the first rib 35a on the mounting surface 34 of the outer case 30A and the mounting foot 50. In this case, use of the space F when welding the mounting foot 50 to a mounting object facilitates welding work such as applying lasers to a welding portion of the mounting foot 50 during laser welding or bringing an electrode into contact with the mounting foot 50 during resistance welding.

The distance between the mounting surface 34 and the mounting foot 50 of the outer case 30A can be adjusted by the shape of the mounting foot 50.

The space F may not be provided between the mounting surface 34 and the mounting foot 50 of the outer case 30A. In this case, the mounting foot 50 may be provided along the mounting surface 34 of the outer case 30A such that the mounting foot 50 is in contact with the mounting surface 34 of the outer case 30A.

Preferably, the mounting foot 50 does not extend past the outer case 30A as viewed in the first direction D1. When the mounting foot 50 does not extend past the outer case 30A as viewed in the first direction D1, the footprint of the capacitor 1A can be reduced, compared to when the mounting foot 50 extends past the outer case 30A. Further, when the mounting foot 50 does not extend past the outer case 30A as viewed in the first direction D1, the capacitors 1A adjacent to each other are less likely to interfere with each other when, for example, the multiple capacitors 1A are aligned in a direction perpendicular to the first direction D1 (i.e., the directions including the second direction D2 and the third direction D3 in the examples shown in FIG. 1 and the like) and mechanically connected to each other, compared to when the mounting foot 50 extends past the outer case 30A.

The mounting foot 50 may extend past the outer case 30A as viewed in the first direction D1. In this case, a portion of the mounting foot 50 that is extending past the outer case 30A can be used as a welding portion, so that no space may be provided between the mounting surface 34 and the mounting foot 50 of the outer case 30A.

The mounting foot 50 may have a plate shape or a linear shape (rod shape), for example. In this case, the mounting foot 50 may have a partially bent shape.

There may be one mounting foot 50 as shown in FIG. 1 and the like, or there may be multiple mounting feet 50.

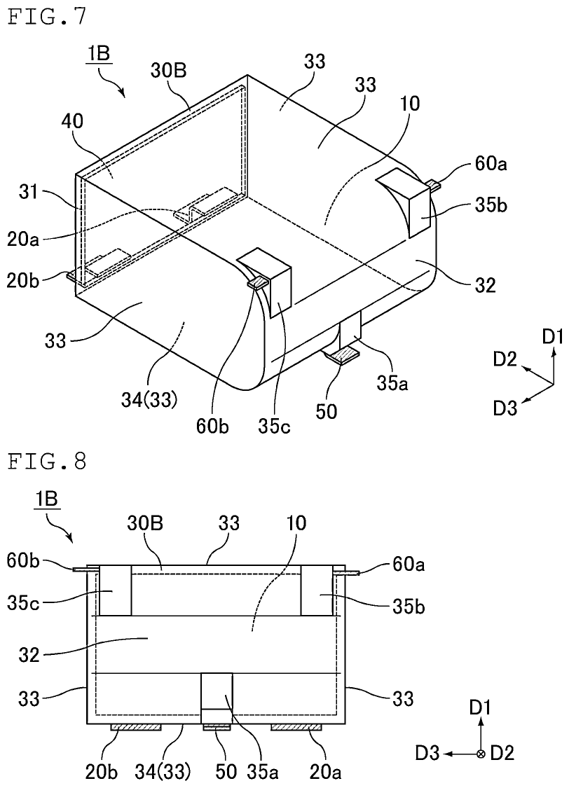

FIG. 7 is a schematic perspective view of another example of the capacitor of the present disclosure. FIG. 8 is a schematic view of the capacitor shown in FIG. 7 as viewed from a first surface side of an outer case.

A capacitor 1B shown in FIG. 7 and FIG. 8 includes an outer case 30B instead of the outer case 30A for the capacitor 1A shown in FIG. 1 and the like.

Outer surfaces of the outer case 30B further include a first fixing foot 60a and a second fixing foot 60b, in addition to the mounting foot 50.

In the examples shown in FIG. 7 and the like, the first fixing foot 60a is attached to a second rib 35b on the second surface 33 as the outer surface of the outer case 30B.

The first fixing foot 60a is attached to the second rib 35b by a method such as insert molding.

In the examples shown in FIG. 7 and the like, the second fixing foot 60b is attached to a third rib 35c on the second surface 33 as the outer surface of the outer case 30B.

The second fixing foot 60b is attached to the third rib 35c by a method such as insert molding.

The second rib 35b and the third rib 35c each may have any shape.

The outer surfaces of the outer case 30B may not be provided with the second rib 35b or the third rib 35c. In other words, a fixing foot may be at a portion other than the second rib 35b and the third rib 35c of the outer case 30B.

The first fixing foot 60a and the second fixing foot 60b are each a mounting foot for welding the outer case 30B to another outer case.

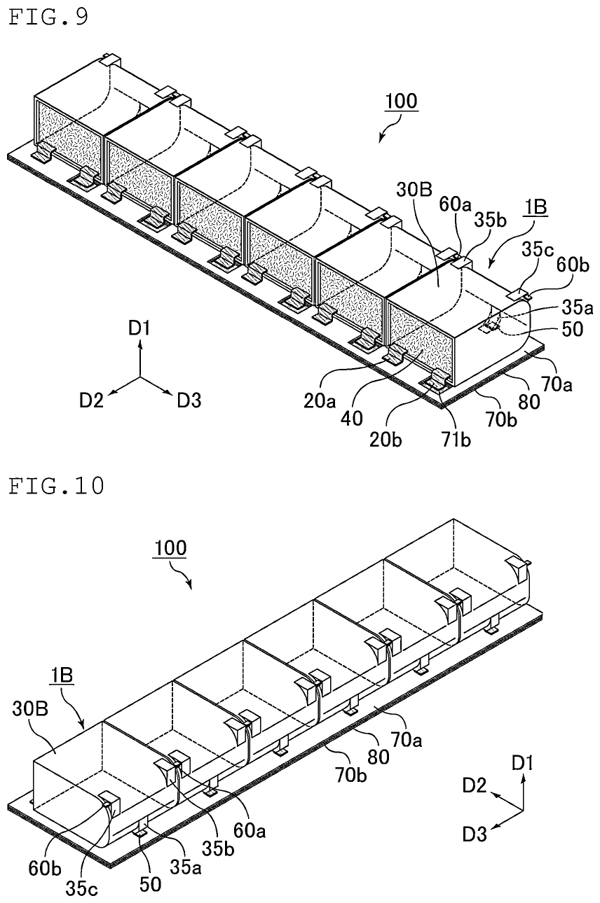

When mechanically connecting the multiple capacitors 1B to each other as shown in FIG. 9 and the like described later, the capacitors 1B adjacent to each other are connected such that the first fixing foot 60a of one capacitor 1B and the second fixing foot 60b of the other capacitor 1B are welded to each other. Thus, the capacitors 1B adjacent to each other, specifically the outer cases 30B adjacent to each other, can be firmly connected to each other, compared to when the first fixing foot 60a and the second fixing foot 60b are connected to each other by screwing, soldering, or the like. This can improve the vibration and shock resistance while the multiple capacitors 1B are mechanically connected to each other.

The first fixing foot 60a is at a position different from that of the mounting foot 50 such that the first fixing foot 60a is electrically isolated from the first lead-out terminal 20a and the second lead-out terminal 20b. In other words, the first fixing foot 60a is electrically isolated from the capacitor element 10 to which the first lead-out terminal 20a and the second lead-out terminal 20b are electrically connected.

The second fixing foot 60b is at a position different from that of the mounting foot 50 such that the second fixing foot 60b is electrically isolated from the first lead-out terminal 20a and the second lead-out terminal 20b. In other words, the second fixing foot 60b is electrically isolated from the capacitor element 10 to which the first lead-out terminal 20a and the second lead-out terminal 20b are electrically connected.

Preferably, the first fixing foot 60a and the second fixing foot 60b are electrically isolated from each other.

Preferably, the first fixing foot 60a and the second fixing foot 60b are each electrically isolated from the mounting foot 50.

Preferably, the first fixing foot 60a and the second fixing foot 60b include a metal material of the same type as that of the first lead-out terminal 20a and the second lead-out terminal 20b. In other words, preferably, the first fixing foot 60a and the second fixing foot 60b include a metal material of the same type as that of the mounting foot 50. In this case, the first fixing foot 60a and the second fixing foot 60b can be welded to each other by the same welding method as that for welding the first lead-out terminal 20a, the second lead-out terminal 20b, and the mounting foot 50 to a mounting object.

Examples of the metal material of the first fixing foot 60a and the second fixing foot 60b include copper, oxygen-free copper, aluminum, and alloys containing at least one of these metals. In particular, the metal material of the first fixing foot 60a and the second fixing foot 60b is preferably copper or oxygen-free copper. When the metal material of the first fixing foot 60a and the second fixing foot 60b is a copper-based material, for example, oxygen-free copper (copper: 99.96 wt % or more), tough pitch copper (copper: 99.90 wt % or more), phosphorus deoxidized copper (copper: 99.90 wt % or more, phosphorus: 0.015 wt % or more, 0.040 wt % or less), or the like can be used.

The first fixing foot 60a and the second fixing foot 60b are welded to each other by a welding method such as laser welding or resistance welding.

As shown in FIG. 7 and the like, preferably, the mounting foot 50 and the first fixing foot 60a are at mutually different height positions in the first direction D1. Further, as shown in FIG. 7 and the like, preferably, the mounting foot 50 and the second fixing foot 60b are at mutually different height positions in the first direction D1. In this case, when mounting the multiple capacitors 1B to a mounting object while mechanically connecting these capacitors 1B to each other, the individual capacitors 1B, specifically the individual outer cases 30B, can be fixed at multiple different height positions. This can sufficiently improve the vibration and shock resistance while the multiple capacitors 1B are mechanically connected to each other.

The first fixing foot 60a and the second fixing foot 60b may be at the same height position in the first direction D1 or at mutually different height positions in the first direction D1.

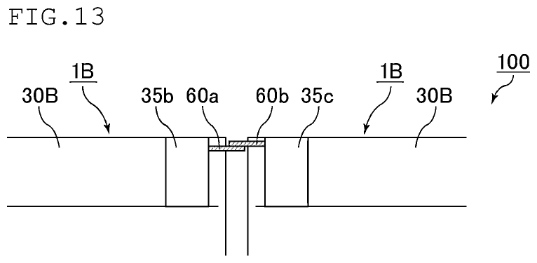

When the first fixing foot 60a and the second fixing foot 60b are at mutually different height positions in the first direction D1, as shown in FIG. 13 described later, the first fixing foot 60a and the second fixing foot 60b can be easily welded to each other at their surfaces facing each other in the first direction D1.

As shown in FIG. 7 and the like, preferably, the mounting foot 50 and the first fixing foot 60a extend in mutually different directions. Further, as shown in FIG. 7 and the like, preferably, the mounting foot 50 and the second fixing foot 60b extend in mutually different directions. In this case, the first fixing foot 60a and the second fixing foot 60b are easily welded to each other while the mounting foot 50 is welded to a mounting object.

When the mounting foot 50 and the first fixing foot 60a extend in mutually different directions, the mounting foot 50 and the first fixing foot 60a may extend in mutually intersecting directions that are perpendicular to the first direction D1. When the mounting foot 50 and the second fixing foot 60b extend in mutually different directions, the mounting foot 50 and the second fixing foot 60b may extend in mutually intersecting directions that are perpendicular to the first direction D1. For example, as shown in FIG. 7 and the like, the mounting foot 50 may extend in the second direction D2, and the first fixing foot 60a and the second fixing foot 60b may extend in the third direction D3. In this case, the first fixing foot 60a and the second fixing foot 60b are easily welded to each other while the mounting foot 50 is welded to a mounting object, with the multiple capacitors 1B being aligned in the third direction D3.

The mounting foot 50 and the first fixing foot 60a may not extend in mutually perpendicular directions. The mounting foot 50 and the second fixing foot 60b may not extend in mutually perpendicular directions.

The first fixing foot 60a and the second fixing foot 60b each may have a plate shape or a linear shape (rod shape), for example. In this case, the first fixing foot 60a and the second fixing foot 60b each may have a partially bent shape.

There may be one first fixing foot 60a and one second fixing foot 60b as shown in FIG. 7 and the like, or there may be one or more first fixing feet 60a and one or more second fixing feet 60b.

The capacitor bank of the present disclosure includes the capacitor of the present disclosure, and the mounting object to which the lead-out terminal and the mounting foot of the capacitor are welded.

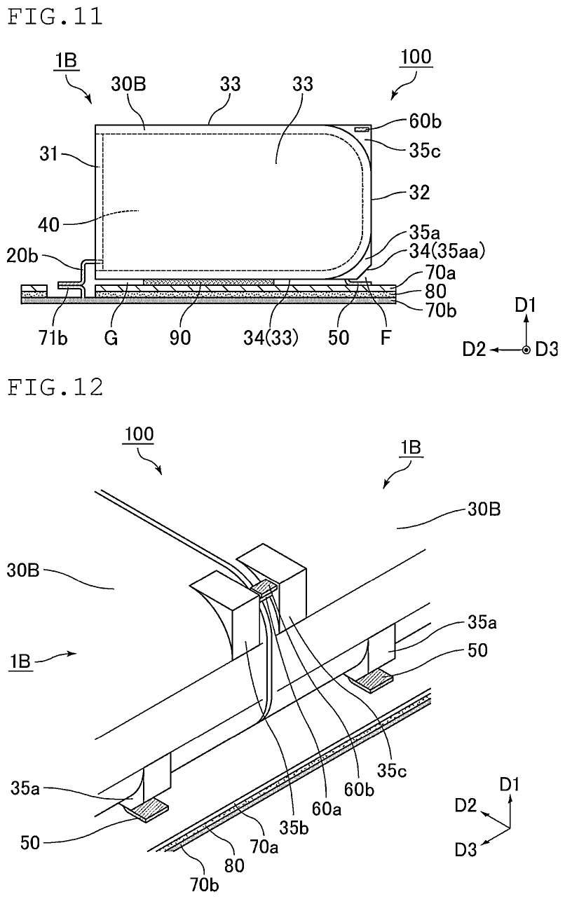

FIG. 9 is a schematic perspective view of an example of the capacitor bank of the present disclosure. FIG. 10 is a schematic perspective view of the capacitor bank shown in FIG. 9 as viewed in a direction different from that in FIG. 9. FIG. 11 is a schematic view of the capacitor bank shown in FIG. 9 and FIG. 10 as viewed from a second surface side of the outer case.

A capacitor bank 100 shown in FIG. 9, FIG. 10, and FIG. 11 includes the multiple capacitors 1B (see FIG. 7 and FIG. 8), a first busbar 70a, and a second busbar 70b.

The first busbar 70a and the second busbar 70b are mounting objects on which the multiple capacitors 1B are mounted.

The first busbar 70a and the second busbar 70b are laminated in the first direction D1. Specifically, the first busbar 70a is closer to the capacitor 1B than the second busbar 70b is in the first direction D1. In other words, the second busbar 70b is on the side opposite the capacitor 1B across the first busbar 70a in the first direction D1.

Examples of constituents of the first busbar 70a and the second busbar 70b include metals such as copper.

An insulating material 80 is provided between the first busbar 70a and the second busbar 70b to ensure insulation therebetween.

Examples of constituents of the insulating material 80 include resins.

As shown in FIG. 9 and FIG. 11, the first busbar 70a and the insulating material 80 are both hollowed out in some areas. At each area where the first busbar 70a and the insulating material 80 are hollowed out, the second busbars 70b are exposed as exposed portions 71b from the first busbar 70a and the insulating material 80.

The multiple capacitors 1B are each mounted on a mounting object including the first busbar 70a and the second busbar 70b at the mounting surface 34 of the outer case 30B. A specific description is given below.

As shown in FIG. 9 and FIG. 11, in each capacitor 1B, the first lead-out terminal 20a is welded to the first busbar 70a, and the second lead-out terminal 20b is welded to the second busbar 70b, here, the exposed portion 71b of the second busbar 70b.

As shown in FIG. 10 and FIG. 11, in each capacitor 1B, the mounting foot 50 is welded to the first busbar 70a. In the case of a single capacitor 1B, the mounting foot 50 is electrically isolated from the first lead-out terminal 20a. In the case of the capacitors 1B in the form of the capacitor bank 100, each mounting foot 50 is electrically connected to the first lead-out terminal 20a via the first busbar 70a

As described above, in the capacitor bank 100, the first lead-out terminal 20a, the second lead-out terminal 20b, and the mounting foot 50 of each capacitor 1B are welded to the mounting object including the first busbar 70a and the second busbar 70b. Thus, in the capacitor bank 100, each capacitor 1B is firmly fixed to the mounting object. This improves the vibration and shock resistance while the multiple capacitors 1B are in the form of the capacitor bank 100 mounted on the mounting object.

Further, the capacitor bank 100 configured as described above can be produced at low cost.

As shown in FIG. 11, in the capacitor bank 100, preferably, the first lead-out terminal 20a, the second lead-out terminal 20b, and the mounting foot 50 of each capacitor 1B protrude outward relative to the mounting surface 34 of the outer case 30B in the first direction D1. In this case, in the capacitor bank 100, a gap G is provided between the mounting surface 34 of the outer case 30B of each capacitor 1B and a mounting object, here, the first busbar 70a.

As shown in FIG. 11, in the capacitor bank 100, preferably, a connecting member 90 is in the gap G such that the connecting member 90 is in contact with the mounting surface 34 of the outer case 30B of each capacitor 1B and the first busbar 70a. In this case, in the capacitor bank 100, each capacitor 1B is connected to the first busbar 70a also via the connecting member 90. For example, with the use of a heat dissipation paste as the connecting member 90, the heat dissipation performance of each capacitor 1B is easily adjusted to a desired level. With the use of an underfill adhesive as the connecting member 90, each capacitor 1B, specifically the outer case 30B of each capacitor 1B, can be sufficiently firmly fixed to the first busbar 70a.

The multiple capacitors 1B are mechanically connected to each other. A specific description is given below.

FIG. 12 is an enlarged schematic view of a portion of the capacitor bank shown in FIG. 10. FIG. 13 is a schematic view of a portion of the capacitor bank shown in FIG. 12 as viewed from a first surface side of the outer case.

As shown in FIG. 12 and FIG. 13, in the capacitor bank 100, the capacitors 1B adjacent to each other are connected such that the first fixing foot 60a of one capacitor 1B and the second fixing foot 60b of the other capacitor 1B are welded to each other. As shown in FIG. 13, in the capacitor bank 100, the first fixing foot 60a and the second fixing foot 60b are at mutually different height positions in the first direction D1, and the first fixing foot 60a and the second fixing foot 60b are welded to each other at their surfaces facing each other in the first direction D1.

As described above, in the capacitor bank 100, the capacitors 1B adjacent to each other, specifically the outer cases 30B adjacent to each other, are welded to each other via the first fixing foot 60a and the second fixing foot 60b. Thus, in the capacitor bank 100, the capacitors 1B adjacent to each other, specifically the outer cases 30B adjacent to each other, are firmly connected to each other. This improves the vibration and shock resistance of the capacitor bank 100 while the multiple capacitors 1B are mechanically connected to each other.

As shown in FIG. 12, in the capacitor bank 100, preferably, the first fixing foot 60a and the second fixing foot 60b are at height positions different from that of the mounting foot 50 in the first direction D1. In this case, in the capacitor bank 100, the individual capacitors 1B, specifically the individual outer cases 30B, are fixed at multiple different height positions. This sufficiently improves the vibration and shock resistance while the multiple capacitors 1B are mechanically connected to each other.

As shown in FIG. 12, in the capacitor bank 100, preferably, the mounting foot 50 and the first fixing foot 60a extend in mutually different directions. Further, as shown in FIG. 12, in the capacitor bank 100, preferably, the mounting foot 50 and the second fixing foot 60b extend in mutually different directions. In this case, when producing the capacitor bank 100, the first fixing foot 60a and the second fixing foot 60b are easily welded to each other while the mounting foot 50 is welded to the first busbar 70a.

As shown in FIG. 12, in the capacitor bank 100, the mounting foot 50 may extend in the second direction D2, and the first fixing foot 60a and the second fixing foot 60b may extend in the third direction D3. In this case, when producing the capacitor bank 100, the first fixing foot 60a and the second fixing foot 60b are easily welded to each other while the mounting foot 50 is welded to a mounting object, with the multiple capacitors 1B being aligned in the third direction D3.

The capacitor bank 100 includes the multiple capacitors 1B. While the capacitor bank 100 shown in FIG. 9 and the like includes six capacitors 1B, the number is not limited.

The capacitor bank 100 includes the multiple capacitors 1B but may include only one capacitor 1B.

In the capacitor bank 100, all the multiple capacitors 1B may be replaced by the capacitors 1A (see FIG. 1, FIG. 2, FIG. 3, and FIG. 4), or one or some of the capacitors 1B may be replaced by one or some capacitors 1A.

In the capacitor bank 100, the busbars such as the first busbar 70a and the second busbar 70b are used as the mounting objects, but substrates, chassis, and the like may be used as the mounting objects, in addition to the busbars.

The capacitor of the present disclosure can improve vibration and shock resistance while it is mounted on a mounting object, and is thus useful as a smoothing capacitor for in-vehicle applications, which is required to have particularly high vibration and shock resistance.

The capacitor bank of the present disclosure can improve the vibration and shock resistance while the capacitor of the present disclosure is mounted on a mounting object, and is thus useful for power conversion equipment (e.g., inverters), which is required to have particularly high vibration and shock resistance.

The present description discloses the following contents.

<1> A capacitor including: a capacitor element including a body and an external electrode on an end surface of the body; a lead-out terminal electrically connected to the external electrode; an outer case housing the capacitor element such that the lead-out terminal protrudes outward therefrom, wherein an outer surface of the outer case includes a mounting surface that faces a mounting object in a first direction when the lead-out terminal is welded to the mounting object; a filling resin filling the outer case such that the capacitor element is embedded in the filling resin; and a mounting foot on the outer surface of the outer case for welding the outer case to the mounting object at the mounting surface, the mounting foot being electrically isolated from the lead-out terminal and including a metal material of a same type as that of the lead-out terminal.

<2> The capacitor according to <1>, wherein the mounting foot protrudes outward relative to the mounting surface of the outer case in the first direction.

<3> The capacitor according to <2>, wherein the mounting foot is dimensioned such that a space is provided between the mounting surface of the outer case and the mounting foot.

<4> The capacitor according to any one of <1> to <3>, wherein the mounting foot does not extend past the outer case as viewed in the first direction.

<5> The capacitor according to any one of <1> to <4>, further including a fixing foot on the outer surface of the outer case for welding the outer case to another outer case, the fixing foot being at a position different from that of the mounting foot, and the fixing foot being electrically isolated from the lead-out terminal.

<6> The capacitor according to <5>, wherein the mounting foot and the fixing foot are at mutually different height positions in the first direction.

<7> The capacitor according to <5> or <6>, wherein the mounting foot and the fixing foot extend in mutually different directions.

<8> The capacitor according <7>, wherein the mounting foot extends in a second direction perpendicular to the first direction, and the fixing foot extends in a third direction perpendicular to the first direction and the second direction.

<9> A capacitor bank including the capacitor

according to any one of <1> to <8>; and the mounting object to which the lead-out terminal and the mounting foot of the capacitor are welded.

<10> A capacitor outer case comprising: a housing body configured to house a capacitor element such that a lead-out terminal of the capacitor element protrudes outward therefrom, wherein an outer surface of the housing body includes a mounting surface; and a mounting foot on the outer surface of the housing body for welding the housing body to a mounting object at a mounting surface, the mounting surface being configured to face the mounting object in a first direction.

### REFERENCE SIGNS LIST

1A, 1B capacitor
10 capacitor element
11 body
12a first external electrode
12b second external electrode
13a first metallized film
13b second metallized film
14a first dielectric film
14aa first main surface of first dielectric film
14ab second main surface of first dielectric film
14b second dielectric film
14ba first main surface of second dielectric film
14bb second main surface of second dielectric film
15a first metal layer
15b second metal layer
20a first lead-out terminal
20b second lead-out terminal
30A, 30B outer case
31 opening
32 first surface of outer case
33 second surface of outer case
34 mounting surface of outer case
35a first rib
35aa first surface of first rib
35b second rib
35c third rib
40 filling resin
50 mounting foot
60a first fixing foot
60b second fixing foot
70a first busbar
70b second busbar
71b exposed portion of second busbar
80 insulating material
90 connecting member
100 capacitor bank
D1 first direction
D2 second direction
D3 third direction
F space
G gap

1. A capacitor comprising:
a capacitor element including a body and an external electrode on an end surface of the body;
a lead-out terminal electrically connected to the external electrode;
an outer case housing the capacitor element such that the lead-out terminal protrudes outward therefrom, wherein an outer surface of the outer case includes a mounting surface that faces a mounting object in a first direction when the lead-out terminal is welded to the mounting object;
a filling resin filling the outer case such that the capacitor element is embedded in the filling resin; and
a mounting foot on the outer surface of the outer case for welding the outer case to the mounting object at the mounting surface, the mounting foot being electrically isolated from the lead-out terminal and including a metal material of a same type as that of the lead-out terminal.

2. The capacitor according to claim 1, wherein the mounting foot protrudes outward relative to the mounting surface of the outer case in the first direction.

3. The capacitor according to claim 2, wherein the lead-out terminal protrudes outward relative to the mounting surface of the outer case in the first direction.

4. The capacitor according to claim 1, wherein the lead-out terminal protrudes outward relative to the mounting surface of the outer case in the first direction.

5. The capacitor according to claim 2, wherein the mounting foot is dimensioned such that a space is provided between the mounting surface of the outer case and the mounting foot.

6. The capacitor according to claim 1, wherein the mounting foot does not extend past the outer case as viewed in the first direction.

7. The capacitor according to claim 1, further comprising a rib on the outer surface of the outer case, wherein the mounting foot is attached to the rib.

8. The capacitor according to claim 1, further comprising a fixing foot on the outer surface of the outer case for welding the outer case to another outer case, the fixing foot being at a position different from that of the mounting foot, and the fixing foot being electrically isolated from the lead-out terminal.

9. The capacitor according to claim 8, wherein the mounting foot and the fixing foot are at mutually different height positions in the first direction.

10. The capacitor according to claim 8, wherein the mounting foot and the fixing foot extend in mutually different directions.

11. The capacitor according to claim 8, further comprising:
a first rib on the outer surface of the outer case, wherein the mounting foot is attached to the first rib; and
a second rib on the outer surface of the outer case, wherein the fixing foot is attached to the second rib.

12. The capacitor according to claim 8, wherein the fixing foot is electrically isolated from the mounting foot.

13. The capacitor according to claim 8, wherein the fixing foot includes a metal material of a same type as that of the lead-out terminal.

14. The capacitor according to claim 10,
wherein the mounting foot extends in a second direction perpendicular to the first direction, and
the fixing foot extends in a third direction perpendicular to the first direction and the second direction.

15. A capacitor bank comprising:
the capacitor according to claim 1; and
the mounting object to which the lead-out terminal and the mounting foot of the capacitor are welded.

16. A capacitor outer case comprising:
a housing body configured to house a capacitor element such that a lead-out terminal of the capacitor element protrudes outward therefrom, wherein an outer surface of the housing body includes a mounting surface; and
a mounting foot on the outer surface of the housing body for welding the housing body to a mounting object at a mounting surface, the mounting surface being configured to face the mounting object in a first direction.

17. The capacitor outer case according to claim 16, wherein the mounting foot protrudes outward relative to the mounting surface of the outer case in the first direction.

18. The capacitor outer case according to claim 16, wherein the mounting foot does not extend past the outer case as viewed in the first direction.

19. The capacitor outer case according to claim 16, further comprising a rib on the outer surface of the outer case, wherein the mounting foot is attached to the rib.

20. The capacitor outer case according to claim 16, further comprising a fixing foot on the outer surface of the outer case for welding the outer case to another outer case, the fixing foot being at a position different from that of the mounting foot.
